(19) United States
(12) Patent Application Publication
(10) Pub. No.: US 2026/0338073 A1
(43) Pub. Date: Oct. 29, 2026

(54) SLOT-HOLE SHOWERHEAD STRUCTURE FOR LEADING EDGE OF TURBINE GUIDE VANE AND DESIGN METHOD THEREOF

(71) Applicant: Northwestern Polytechnical University, Xi'an (CN)

(72) Inventors: Lin Ye, Xi'an (CN); Cunliang Liu, Xi'an (CN); Bingran Li, Ningbo (CN); Xinyu Wang, Xinxiang (CN); Hongxu She, Wuhu (CN); Xiyuan Liang, Liaoyang (CN)

(21) Appl. No.: 19/720,435

(22) Filed: Jun. 25, 2026

(30) Foreign Application Priority Data
Sep. 15, 2025 (CN) 202511308830.5

(51) Int. Cl. F01D 5/18; F01D 9/02

(52) U.S. Cl. CPC F01D 5/186; F01D 9/02; F05D 2230/00; F05D 2240/121; F05D 2260/202

(57) ABSTRACT

Provided are a slot-hole showerhead structure for a leading edge of a turbine guide vane and a design method thereof. The structure includes a plurality of rows of slot holes formed in a leading edge of a vane, where a quantity of hole rows is determined based on a total mass flow rate of a coolant and a preset blowing ratio range; a hole row spacing is determined via iterative optimization; and an exit of each slot hole has a special rotation angle. The design method includes: determining the quantity of hole rows according to the total mass flow rate of the coolant and the preset blowing ratio range; with the peak value of the cooling effectiveness as a target, iteratively optimizing the hole row spacing row by row; and quantitatively computing an exit rotation angle of the slot hole based on an aerodynamic parameter.

### CROSS-REFERENCE TO RELATED APPLICATIONS

This patent application claims the benefit and priority of Chinese Patent Application No. 202511308830.5 filed with the China National Intellectual Property Administration on Sep. 15, 2025, the disclosure of which is incorporated by reference herein in its entirety as part of the present application.

### TECHNICAL FIELD

The present disclosure belongs to the technical field of cooling for turbine guide vanes of aero-engines, and particularly relates to a slot-hole showerhead structure for a leading edge of a turbine guide vane and a design method thereof.

### BACKGROUND

With the continuous performance improvement of advanced gas turbine engines, turbine inlet temperatures (TITs) have increased in a stepwise manner. At present, the TITs of advanced aero-engines commonly can reach 2000 K or higher, greatly exceeding temperature endurance limits of hot-end components. The leading edge of the turbine vanes serves as a key region directly exposed to high-temperature gas, and its cooling effectiveness determines the service life of the vanes and the reliability of the engines. Accordingly, efficient cooling measures are imperative. Conventional showerhead cooling designs with cylindrical holes have gradually approached their performance limits under extreme high-temperature conditions, failing to meet future cooling requirements. Meanwhile, advances in hole machining processes have laid a technical foundation for fabrication of more complex and higher-performance shaped holes such as slot holes in leading edge regions.

Existing research shows that shaped holes (particularly expanded holes or slot holes) exhibit better cooling performance on the leading edges of the turbine vanes than conventional cylindrical holes. For example, Zhu Huiren et al. from Northwestern Polytechnical University (see Experimental Research on Film Cooling Characteristics of Cylindrical Hole and Expanding Hole on the Leading Edge, Journal of Aerospace Power, 2010, 25 (7): 1464-1470) tested film cooling characteristics of the expanded holes and the cylindrical holes on the leading edges of the vanes using a transient liquid crystal measurement technique. Their test results clearly demonstrate that the conventional cylindrical holes have undesirable spanwise film cooling effectiveness and insufficient film coverage. By contrast, the expanded holes feature a greater spanwise width and a lower spanwise jet velocity, yielding better flow adhesion to the wall under the mainstream, and better cooling coverage. This proves that the conventional showerhead cooling with the cylindrical holes cannot meet cooling requirements on the leading edges of the modern high-performance turbine vanes.

According to the recent research (see Film Cooling Effectiveness Investigation of Diffusion Slot Holes on a Turbine Guide Vane Leading Edge, International Communications in Heat and Mass Transfer, 2024, 158:107845), slot holes with different expansion angles are further designed in different hole row layouts for the leading edges of the turbine vanes. Experimental results show that the expanded slot holes exhibit remarkably better film cooling effectiveness than the cylindrical holes in any hole row layout, which verifies that the slot holes are well compatible with the leading edges of the turbine vanes. However, when key parameters of the slot holes, specifically the exit rotation directions (i.e., rotation angles of hole exit about their axes), are designed, only a qualitative empirical approach is used. That is, the rotation angles should increase gradually as positions of film holes are away from a stagnation line of the leading edge. This design approach lacks definite theoretical foundations and systematic design methods, and cannot provide guiding principles and computational support for quantitative determination of optimal rotation angles at different specific positions.

To sum up, the slot holes have been verified as effective structures to enhance the cooling effectiveness of the leading edges. Nevertheless, prominent defects remain in the structural design of the slot holes of the leading edges. Most current studies conduct optimization via trial-and-error traversal of structural parameters (including hole profiles, expansion angles and positions). Such an approach is tedious and time-consuming with high computational and experimental costs, and no universal systematic design procedure is available. On the other hand, design criteria for key parameters are insufficient. Particularly, for the exit rotation angles of the slot holes, which are critical parameters greatly affecting the cooling performance, the prior art cannot provide a scientific design method based on physical mechanisms to quantitatively compute and determine optimal values at different positions.

### SUMMARY

In view of undesirable film coverage of slot-hole structures for the leading edges of the turbine guide vanes caused by insufficient theoretical bases for exit rotation angles, and suboptimal overall cooling effectiveness due to unsystematically optimized hole row layout in the prior art, the present disclosure provides a slot-hole showerhead structure for a leading edge of a turbine guide vane and a systematic and efficient design method of the slot-hole showerhead structure for a leading edge of a turbine guide vane. The present disclosure provides definite theoretical guidance and a practical engineering approach for design and optimization of efficient cooling structures for the leading edge of the turbine vane.

To achieve the above objective, the present disclosure provides the following technical solutions.

An aspect of the present disclosure provides a slot-hole showerhead structure for a leading edge of a turbine guide vane, including: a plurality of rows of slot holes formed in a leading edge of a vane, where the plurality of rows of slot holes are arranged in parallel along a vane height direction;
a quantity of hole rows for the slot holes is determined based on a total mass flow rate of a coolant on the leading edge of the vane and a preset blowing ratio range;
a hole row spacing is determined via iterative optimization, such that area-averaged film cooling effectiveness of each hole row on the leading edge of the vane reaches a peak value; and
an exit rotation angle of each slot hole is set, such that a broad edge of the slot hole is perpendicular to a resultant vector direction for a coolant mass flux and a mainstream mass flux at a hole exit.

Another aspect of the present disclosure provides a design method of a slot-hole showerhead structure for a leading edge of a turbine guide vane, including following steps:
step 1, determining the quantity of hole rows: based on the total mass flow rate of the coolant on the leading edge of the turbine vane and a total cross-sectional area of the slot holes, selecting, via iterative computation, the quantity of hole rows meeting the preset blowing ratio range;
step 2, determining positions of hole rows: according to a geometrical boundary of the leading edge of the vane, setting a first hole row at a stagnation line of the leading edge; and with a minimum safe spacing as a constraint, determining remaining hole rows at two sides of the stagnation line via row-by-row iterative optimization, such that the area-averaged film cooling effectiveness of the hole row on the leading edge of the vane reaches the peak value; and
step 3, designing the exit rotation angle of the slot hole, including following sub-steps:
sub-step 3.1, for a determined opening position of the slot hole, extracting a mainstream total pressure, a mainstream static pressure, a mainstream density, a coolant velocity, and a coolant density via numerical simulation;
sub-step 3.2, through the mainstream total pressure, the mainstream static pressure, and the mainstream density of the opening position, computing a mainstream velocity of the opening position, and further computing a corresponding mainstream mass flux:

$${v}_{g}^{kj} = \sqrt{\frac{2 ( {P}_{t}^{kj} - {P}_{s}^{kj} )}{{ρ}_{g}^{kj}}}$$

$${τ}_{g}^{kj} = {ρ}_{g}^{kj} {v}_{g}^{kj}$$

where, k is a row number of the slot hole, j is a number of the slot hole in each row, v_{g} is the mainstream velocity, Pₜ is the mainstream total pressure, Pₛ is the mainstream static pressure, ρ_{g} is the mainstream density, and τ_{g} is the mainstream mass flux;
sub-step 3.3, through the coolant velocity and the coolant density of the opening position, computing a coolant mass flux of the opening position:

$${τ}_{c}^{kj} = {ρ}_{c}^{kj} {v}_{c}^{kj}$$

where, τ_{c} is the coolant mass flux, ρ_{c} is the coolant density, and v_{c} is the coolant velocity; and
sub-step 3.4, according to the mainstream mass flux and the coolant mass flux of the opening position, computing the exit rotation angle of the slot hole:

$${θ}^{kj} = arctan \frac{{τ}_{c}^{kj} cos γ}{{τ}_{g}^{kj}}$$

where, θ is the exit rotation angle of the slot hole, and γ is a hole inclination angle of the slot hole.

Further, the step 1 specifically includes:
sub-step 1.1, preliminarily selecting the quantity of hole rows, determining a quantity of slot holes in the row, and computing the total cross-sectional area of the slot holes;
sub-step 1.2, according to cooling design requirements, determining the total mass flow rate of the coolant on the leading edge of the turbine vane, and computing an average blowing ratio for the leading edge of the vane:

$$\overline{M} = \frac{{\dot{m}}_{c} / {A}_{e}}{{\overline{ρ}}_{g} {\overline{v}}_{g}}$$

where, M̅ is the average blowing ratio, \dot{m}_{c} is the total mass flow rate of the coolant, Aₑ is the total cross-sectional area of the slot holes, ρ̅_{g} is an average mainstream density, and v̅_{g} is an average mainstream velocity; and
sub-step 1.3, determining whether the computed average blowing ratio is within the preset blowing ratio range; if yes, determining the quantity of hole rows; and if no, returning to the step 1.1 to redetermine the quantity of hole rows.

Further, in the step 1.3, the preset blowing ratio range is 1.5 to 2.0.

Further, in the step 1.1, the total cross-sectional area of the slot holes is computed by equivalently taking the slot holes as circular holes:

$${A}_{e} = Mw \frac{π {D}^{2}}{4}$$

where, N is the quantity of hole rows, w is the quantity of slot holes in the row, and D is an equivalent diameter of the slot hole.

Further, in the step 1.1, the quantity of slot holes in the row is determined by a vane height, a hole spacing in the row, and a reserved size at a top of the vane and a root of the vane.

Further, in the step 1.1, the hole spacing in the row is 3 D to 5 D.

Further, in the step 1.1, the reserved size at the top of the vane and the root of the vane is 8 D to 15 D.

Further, the row-by-row iterative optimization in the step 2 includes:
sub-step 2.1, for a k th hole row, generating an arithmetic candidate spacing

$${s}_{k}^{i} = ( 2 + 0.1 i ) D ,$$

i=0, 1, 2 . . . , and D being an equivalent diameter of the slot hole;
sub-step 2.2, computing area-averaged film cooling effectiveness

$${η}_{k}^{i}$$

of the k th hole row on the leading edge under each candidate spacing

$${s}_{k}^{i}$$

via numerical simulation; and
sub-step 2.3, terminating iteration if

$${η}_{k}^{i} > {η}_{k}^{i + 1} ,$$

determining

$${η}_{k}^{i}$$

as peak cooling effectiveness, and selecting

$${s}_{k}^{i}$$

as an optimal spacing.

The present disclosure has the following advantages:
1. By setting the exit rotation angle of each slot hole such that a broad edge of the slot hole is perpendicular to the resultant vector direction for the coolant mass flux and the mainstream mass flux at this position, the slot-hole showerhead structure for a leading edge of a turbine guide vane provided by the present disclosure fundamentally ensures that the coolant jet flows out in a direction most favorable for adhesion to the wall, greatly improving the coverage integrity and uniformity of the film. All hole row layouts in the structure are optimized based on a peak value of the area-averaged film cooling effectiveness, such that cooling gas flows cooperate efficiently between front and rear hole rows and maximizes the utilization of the coolant, thereby realizing optimal cooling effectiveness over the entire leading edge region.
2. The design method of the slot-hole showerhead structure for a leading edge of a turbine guide vane provided by the present disclosure first dynamically determines an optimal quantity of hole rows based on a total mass flow rate of the coolant, ensuring efficient distribution of cooling resources. Through the row-by-row iterative optimization on the hole row spacing, the hole layout corresponding to the peak value of the film cooling effectiveness is accurately positioned, which breaks through the limitations of traditional empirical hole arrangement. Most importantly, driven by physical mechanisms, the resultant vector direction for the tangential component of the coolant mass flux and the mainstream mass flux is quantitatively computed at each opening position to scientifically determine the exit rotation angle of the slot hole, such that the coolant jet covers the wall in the optimal direction perpendicular to the broad edge. This completely solves the problem of blindly adjusting the position and rotation angle of the slot hole based on qualitative experience in the prior art.
3. The design method of the present disclosure not only greatly reduces the computational cost and trial-and-error cycle required by the traditional exhaustive hole optimization, but also significantly improves the film coverage efficiency and cooling uniformity of the slot holes through a systematic procedure, providing a quantifiable and reusable design paradigm for high-performance leading edge cooling structures of the turbine vanes.

### BRIEF DESCRIPTION OF THE DRAWINGS

The foregoing and/or other features and advantages of the present disclosure will be understood more easily with reference to the following description of the accompanying drawings. The accompanying drawings are not drawn to scale, and some features are enlarged or reduced to show the details of specific components. In the drawings:

FIG. 1 is a schematic view of a model of a showerhead structure for a leading edge of a turbine guide vane at a center of a vane height according to an embodiment of the present disclosure;

FIG. 2 is a schematic cross-sectional view of a slot hole according to an embodiment of the present disclosure;

FIG. 3 is a flowchart of a design method of a slot-hole showerhead structure for a leading edge of a turbine guide vane according to an embodiment of the present disclosure;

FIG. 4 is a flowchart for determining a quantity of hole rows for slot holes according to an embodiment of the present disclosure;

FIG. 5 is a flowchart for determining positions of hole rows for slot holes according to an embodiment of the present disclosure;

FIG. 6 illustrates a design method of an exit rotation direction of a slot hole according to an embodiment of the present disclosure;

FIG. 7 is a schematic plan of a slot-hole showerhead structure according to an embodiment of the present disclosure, in which an arrangement structure for each row of slot holes is illustrated;

FIG. 8 is a schematic partially cross-sectional view of a slot-hole showerhead structure according to an embodiment of the present disclosure, in which a hole spacing and a hole inclination angle for each row of slot holes are illustrated;

FIG. 9 illustrates a film cooling computational domain of a plane cascade with coolant outflow from slot holes according to an embodiment of the present disclosure;

FIG. 10 illustrates a coolant velocity streamline of slot holes with different exit rotation angles on a leading edge according to an embodiment of the present disclosure;

FIG. 11 illustrates a film cooling effectiveness distribution of slot holes with different exit rotation angles on a leading edge according to an embodiment of the present disclosure; and

FIG. 12 illustrates radial film cooling effectiveness distributions at 3D and 6D after slot holes with different exit rotation angles according to an embodiment of the present disclosure.

In the figures: 10—suction side, and 20—pressure side.

### DETAILED DESCRIPTION OF EMBODIMENTS

The present disclosure is described in detail below with reference to the accompanying drawings and exemplary embodiments of the present disclosure. It is to be noted that the following detailed description of the present disclosure is merely used for illustration, rather than limitation to the present disclosure.

Through iterative optimization on a hole row layout and mass flux decomposition based quantitative design on an exit rotation angle, the slot-hole showerhead structure for a leading edge of a turbine guide vane and the design method thereof provided by embodiments of the present disclosure significantly improve the engineering adaptability and performance ceiling of the leading edge cooling structure of the vane.

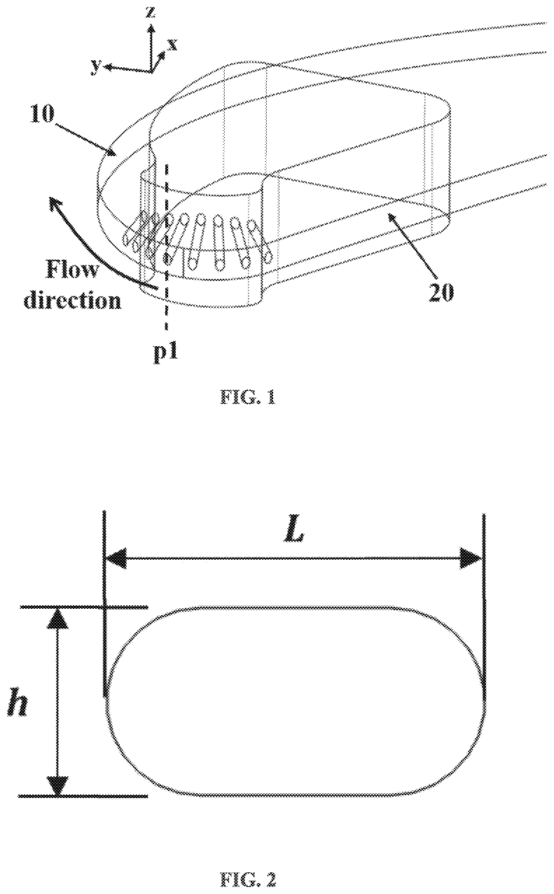

Referring to FIG. 1, as an exemplary embodiment of the present disclosure, a slot-hole showerhead structure for a leading edge of a turbine guide vane includes a plurality of rows of slot holes formed in a leading edge of a vane. The plurality of rows of slot holes are arranged in parallel along a vane height direction, i.e., a Z direction. FIG. 1 schematically illustrates a fluid domain model of the leading edge at a center of a vane height. This figure only illustrates one slot hole in various rows of slot holes along the vane height direction. The slot hole is located at a central position in the vane height direction.

According to the present disclosure, a quantity of hole rows for the slot holes is determined based on a total mass flow rate of a coolant on the leading edge of the vane and a preset blowing ratio range. A hole row spacing is determined via iterative optimization, such that area-averaged film cooling effectiveness of each hole row on the leading edge of the vane reaches a peak value. The hole row layout is designed by optimizing the peak value of the area-averaged film cooling effectiveness, such that cooling gas flows can cooperate efficiently between front and rear hole rows, thereby maximizing the utilization of the coolant and achieving optimal cooling effectiveness across the entire leading edge region.

An exit rotation angle of each slot hole is set, such that a broad edge of the slot hole is perpendicular to a resultant vector direction for a coolant mass flux and a mainstream mass flux at a hole exit. With such a film-hole design method in which the exit rotation angle of the slot hole is designed based on the film cooling theory, the broad edge of the slot hole is perpendicular to the resultant vector direction for the coolant mass flux and the mainstream mass flux at the hole exit. In this way, the coolant jet covers the wall in an optimal direction perpendicular to the broad edge, thereby improving the film coverage and cooling uniformity of the slot holes to adapt to cooling requirements at different positions.

Referring to FIG. 2, in this embodiment, all slot holes have a same cross-sectional area, with an aspect ratio being AS=L/h=2, a broad edge L being 0.8 mm, and a narrow edge h being 0.4 mm.

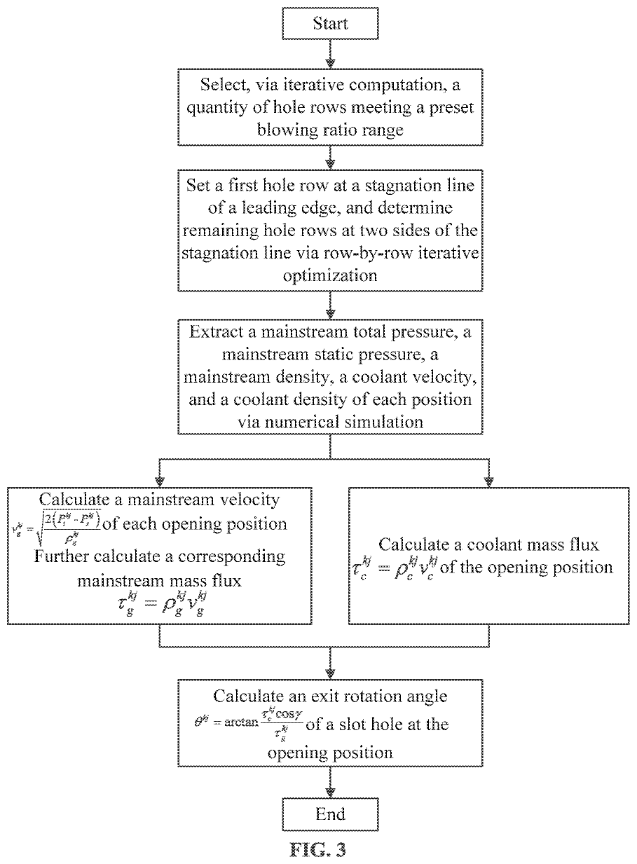

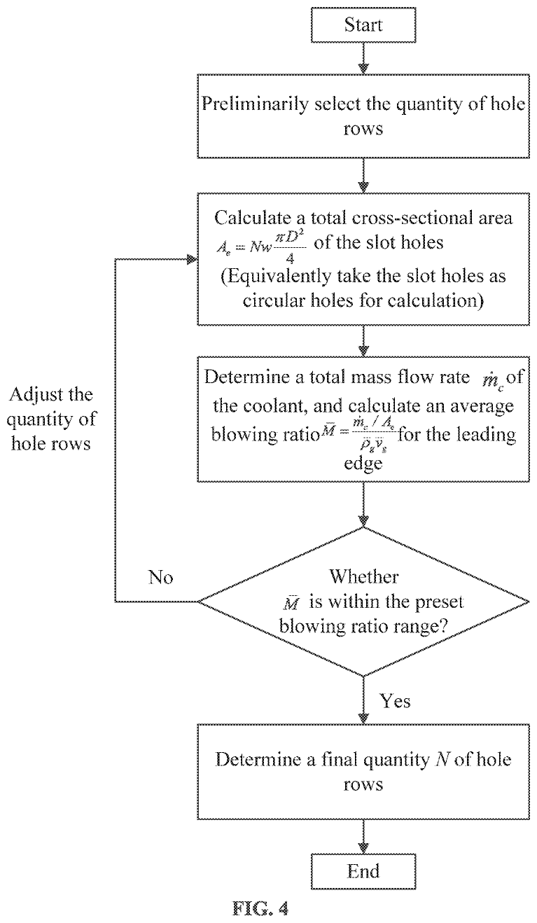

Referring next to FIG. 3, as an exemplary embodiment of the present disclosure, to design the slot-hole showerhead structure for a leading edge of a turbine guide vane, a design method of the slot-hole showerhead structure for a leading edge of a turbine guide vane includes following steps:

Step 1, the quantity of hole rows is determined: Based on the total mass flow rate of the coolant on the leading edge of the turbine vane and a total cross-sectional area of the slot holes, the quantity of hole rows meeting the preset blowing ratio range is selected via iterative computation.

Step 2, positions of hole rows are determined: According to a geometrical boundary of the leading edge of the vane, a first hole row is set at a stagnation line of the leading edge. With a minimum safe spacing as a constraint, remaining hole rows at two sides of the stagnation line are determined via row-by-row iterative optimization, such that the area-averaged film cooling effectiveness of the hole row on the leading edge of the vane reaches the peak value.

Step 3, the exit rotation angle of the slot hole is designed: For each determined hole in each row, flow parameters of a mainstream and a coolant are extracted, and the exit rotation angle of the slot hole is quantitatively computed, such that the coolant jet can optimally cover the wall.

Referring also to FIG. 1, a row of slot holes located at the stagnation line of the leading edge is called the first hole row (a row of holes on a right side of the hole row at pl), and hole rows on two sides thereof are respectively a hole row on a suction side 10 and a hole row on a pressure side 20. The hole rows on the two sides are structurally designed in a same method.

Referring to FIG. 4, in this embodiment, Step 1 includes following sub-steps:
Sub-step 1.1, the quantity of hole rows is preliminarily selected, a quantity of slot holes in the row is determined, and the total cross-sectional area of the slot holes is computed. The total cross-sectional area of the slot holes refers to a sum of cross-sectional areas of all slot holes. Specifically, the total cross-sectional area of the slot holes may be computed by equivalently taking the slot holes as circular holes:

$${A}_{e} = Mw \frac{π {D}^{2}}{4}$$

where, N is the quantity of hole rows, w is the quantity of slot holes in the row, and D is an equivalent diameter of the slot hole. According to a size of the slot hole, the equivalent diameter of the slot hole is computed as 0.6 mm.

In addition, in this embodiment, the quantity of slot holes in the row is determined by a vane height, a hole spacing in the row, and a reserved size at a top of the vane and a root of the vane. The hole spacing in the row is set to 3 D to 5 D. Herein, the hole spacing is selected as 3.6D The reserved size at the top of the vane and the root of the vane is set to 8 D to 15 D. Herein, the reserved size is selected as 11D. Since the vane height is 132 mm, there are 56 slot holes in the row.

Sub-step 1.2, according to cooling design requirements, the total mass flow rate of the coolant on the leading edge of the turbine vane is determined, and an average blowing ratio for the leading edge of the vane is computed:

$$\overline{M} = \frac{{\dot{m}}_{c} / {A}_{e}}{{\overline{ρ}}_{g} {\overline{v}}_{g}}$$

where, M̅ is the average blowing ratio, \dot{m}_{c} is the total mass flow rate of the coolant, Aₑ is the total cross-sectional area of the slot holes, ρ̅_{g} is an average mainstream density, and v̅_{g} is an average mainstream velocity.

Sub-step 1.3, whether the computed average blowing ratio is within the preset blowing ratio range is determined. If yes, the quantity of hole rows is determined. If no, Step 1.1 is returned to redetermine the quantity of hole rows. Therefore, the finally determined quantity of hole rows is N.

In this embodiment, the preset blowing ratio range in Step 1.3 is 1.5 to 2.0. This range is obtained through numerous experiments and simulation data.

In this embodiment, the quantity of hole rows is preliminarily selected as 5. The average blowing ratio computed through Step 1.1 and Step 1.2 is greater than 2. By constantly increasing the quantity of hole rows to 8, the computed average blowing ratio is within the preset blowing ratio range of 1.5 to 2.0. Therefore, the finally determined quantity of hole rows is 8.

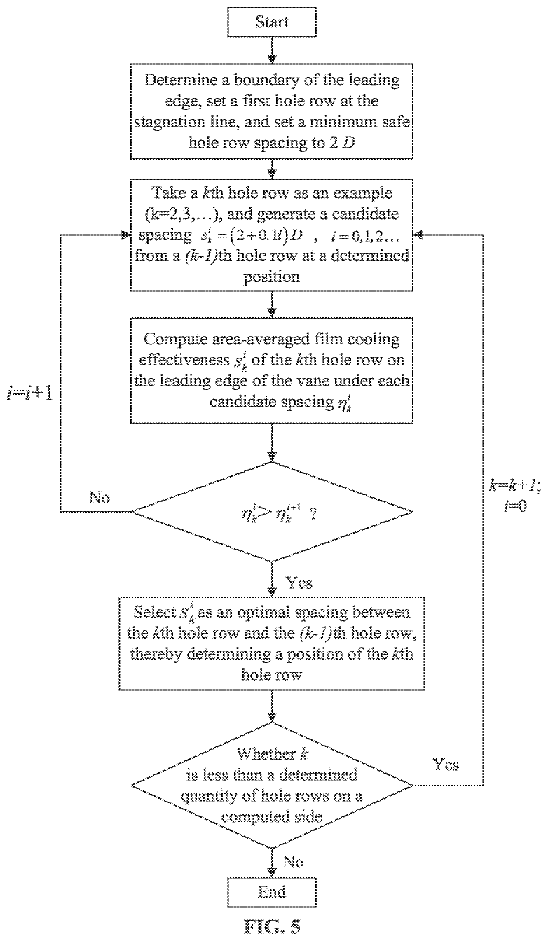

Referring to FIG. 5, in this embodiment, the row-by-row iterative optimization in Step 2 is realized as follows:

Step 2.1, for a k th hole row (k=2, 3 . . . ), an arithmetic candidate spacing

$${s}_{k}^{i} = ( 2 + 0.1 i ) D$$

is generated, i=0, 1, 2 . . . , and D being an equivalent diameter of the slot hole. Thus, the minimum safe spacing between the hole rows is set to 2D=1.2 mm. It should be noted that k mentioned herein refers to the hole row located on the two sides of the stagnation line. A value of k is associated with the quantity N of hole rows finally determined in Step 1. In case of an odd quantity of hole rows, the quantity of hole rows on the two sides of the stagnation line is (N−1)/2 In case of an even quantity of hole rows, a quantity of hole rows on one of the suction side and the pressure side is N/2, and a quantity of hole rows on the other side is (N/2)−1 In actual computation, a hole row on the suction side is preferentially determined. A hole row on the pressure side may be obtained via same computation.

Sub-step 2.2, area-averaged film cooling effectiveness

$${η}_{k}^{i}$$

of the k th hole row on the leading edge under each candidate spacing

$${s}_{k}^{i}$$

is computed via numerical simulation.

Sub-step 2.3, cooling effectiveness values of the hole row on the leading edge of the vane under adjacent candidate spacings are compared. If

$${η}_{k}^{i} > {η}_{k}^{i + 1} ,$$

iteration is terminated,

$${η}_{k}^{i}$$

is determined as peak cooling effectiveness, and

$${s}_{k}^{i}$$

is selected as an optimal spacing. Otherwise, the spacing is continuously expanded, until hole rows on the two sides are all determined.

This step dynamically adjusts the hole row spacing based on a relationship between the film cooling effectiveness and the hole row layout, thereby optimizing the positions of the hole rows row by row to achieve the optimal film cooling effectiveness. This improves the film cooling effectiveness, and achieves the wider coolant coverage.

In this embodiment, a hole row spacing on the suction side is sequentially 2 D, 2.2 D, 2.4 D, and 3 D, while a hole row spacing on the pressure side is sequentially 2.8 D, 2.9 D, and 2.7 D. So far, in the slot-hole showerhead structure for the leading edge of the vane, the quantity of hole rows for the slot holes, the positions of the hole rows, the quantity of holes in each row, and the hole spacing have been determined. Then, by only determining a hole inclination angle and an exit rotation angle of each slot hole, the whole layout of the slot-hole showerhead structure can be determined.

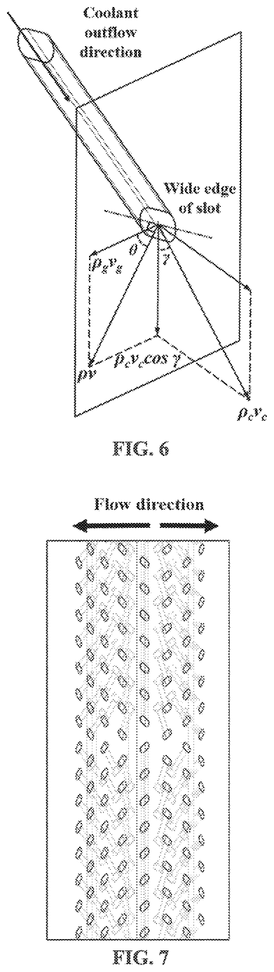

Referring to FIG. 6, in this embodiment, the exit rotation angle of the slot hole in Step 3 is designed as follows:

Sub-step 3.1, for a determined opening position of the slot hole, a mainstream total pressure, a mainstream static pressure, a mainstream density, a coolant velocity, and a coolant density are extracted via numerical simulation.

In this embodiment, taking the slot hole at pl in FIG. 3, i.e., at the center of the vane height, as an example, the mainstream total pressure is 108826 Pa, the mainstream static pressure is 108100 Pa, and the mainstream density is 1.255 kg/m³.

Sub-step 3.2, through the mainstream total pressure, the mainstream static pressure, and the mainstream density of the opening position, a mainstream velocity of the opening position is computed, and a corresponding mainstream mass flux is further computed:

$${v}_{g}^{kj} = \sqrt{\frac{2 ( {P}_{t}^{kj} - {P}_{s}^{kj} )}{{ρ}_{g}^{kj}}}$$

$${τ}_{g}^{kj} = {ρ}_{g}^{kj} {v}_{g}^{kj}$$

where, k is a row number of the slot hole, j is a number of the slot hole in the row, v_{g} is the mainstream velocity, Pₜ is the mainstream total pressure, Pₛ is the mainstream static pressure, ρ_{g} is the mainstream density, and τ_{g} is the mainstream mass flux.

In this embodiment, at pl, the mainstream velocity is 34.014 m/s, and the mainstream mass flux is 42.688 kg/(m²·s).

Sub-step 3.3, through the coolant velocity and the coolant density of the opening position, a coolant mass flux of the opening position is computed:

$${τ}_{c}^{ki} = {ρ}_{c}^{kj} {v}_{c}^{kj}$$

where, τ_{c} is the coolant mass flux, ρ_{c} is the coolant density, and v_{c} is the coolant velocity.

In this embodiment, the coolant mass flux at pl is 87.188 kg/(m²·s).

Sub-step 3.4, according to the mainstream mass flux and the coolant mass flux of the opening position, the exit rotation angle of the slot hole is computed:

$${θ}^{kj} = arctan \frac{{τ}_{c}^{kj} cos γ}{{τ}_{g}^{kj}}$$

where, θ is the exit rotation angle of the slot hole, γ is a hole inclination angle of the slot hole, and τ_{c} cos γ is a component of the coolant mass flux along the vane height direction.

This step designs the exit rotation angle of the slot hole based on the film cooling theory. By determining the resultant vector direction for the coolant mass flux and the mainstream mass flux, the broad edge of the slot hole is perpendicular to the resultant vector. In this way, the coolant jet covers the wall in an optimal direction perpendicular to the broad edge, thereby improving the film coverage and cooling uniformity of the slot hole to adapt to cooling requirements at different positions.

In combination with FIG. 1 and FIG. 6, the hole inclination angle of the slot hole refers to an included angle between the hole axis and the wall. The exit rotation angle of the slot hole refers to an angle rotated by the hole axis about a center of the film hole. If θ is 0°, the broad edge of the slot hole is parallel to the vane height direction. If θ is 90°, the broad edge of the slot hole is perpendicular to the vane height direction.

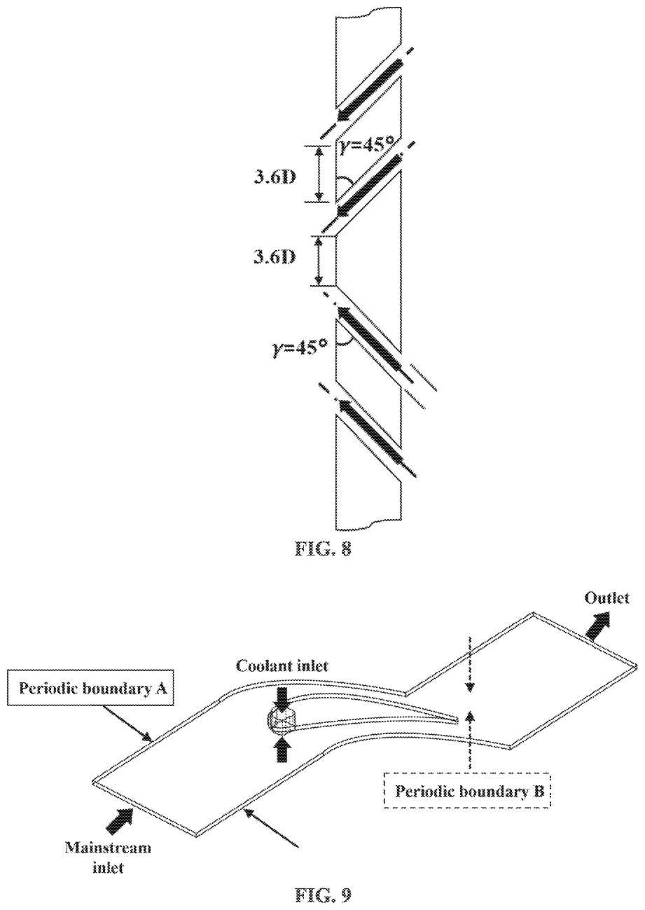

According to the present disclosure, the hole inclination angle may be selected freely. In this embodiment, taking the hole inclination angle of 45° as an example, the exit rotation angle of the slot hole at pl is 55°. Exit rotation angles of other slot holes are computed in the same manner as the exit rotation angle of the slot hole at pl in this embodiment. Thus, the exit rotation angle of each slot hole in all hole rows can be obtained, thereby obtaining the slot-hole showerhead structure for the leading edge of the vane in FIG. 7 and FIG. 8. The flow direction indicated by the arrow in FIG. 7 is the flow direction of the coolant jet with the mainstream.

Referring next to FIG. 9, to verify the design method provided by the present disclosure, three-dimensional (3D) modeling is performed on the slot hole with the exit rotation angle of 55° at pl in this embodiment, to obtain a film cooling computational domain of a plane cascade. Same modeling is performed on slot holes with exit rotation angles of 0°, 45°, and 90° at this position.

Then, meshing and 3D simulating computation are performed on corresponding film cooling computational domains of the plane cascades, to obtain a film cooling effectiveness distribution for the slot holes with different exit rotation angles at pl. Specifically, the computational domain is partitioned with tetrahedral meshes, irrelevant verification on the meshing is performed, and relevant conditions are set. A shear stress transport (SST) k-ω model is selected as the turbulence model, a velocity inlet and a pressure outlet are used by the mainstream, a mass-flow inlet is used by the coolant, and the coolant-to-mainstream density ratio is 3.0.

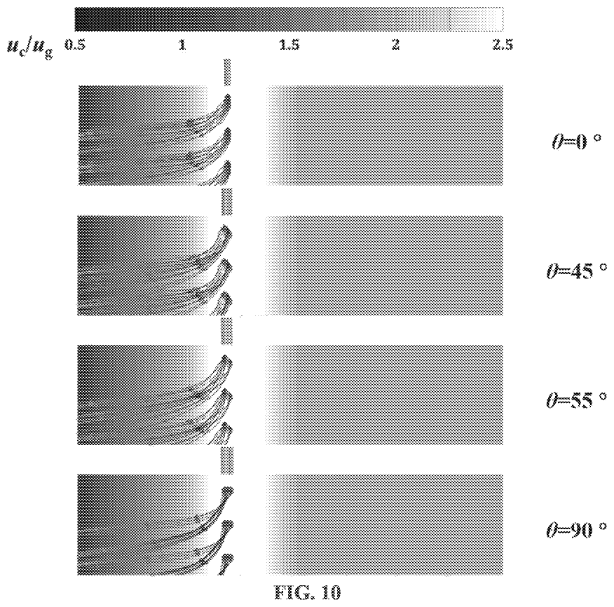

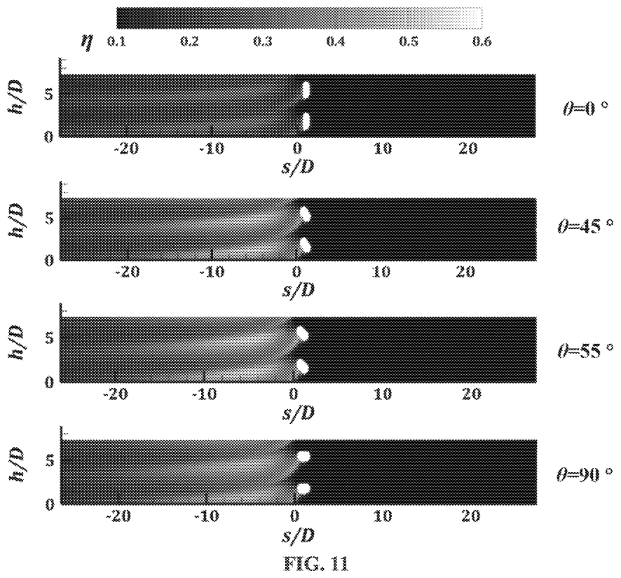

FIG. 10 and FIG. 11 respectively illustrate a coolant velocity streamline and a film cooling effectiveness distribution of a slot hole with a rotation angle obtained with the design method of the present disclosure and a slot hole with a general exit rotation angle on the leading edge of the vane. In FIG. 10, the scale u_{c}/u_{g} represents a dimensionless velocity of the coolant jet, the curve represents a streamline of the coolant jet, and the coolant coverage can be observed. In FIG. 11, the scale η represents film cooling effectiveness, and grayscale values correspond to different levels of film cooling effectiveness in the scale. From the above results, it can be seen that the film with the slot holes obtained by the design method of the present disclosure has wider coverage between the holes and after the holes, and the cooling effectiveness is improved to different extents compared with other slot-hole structures.

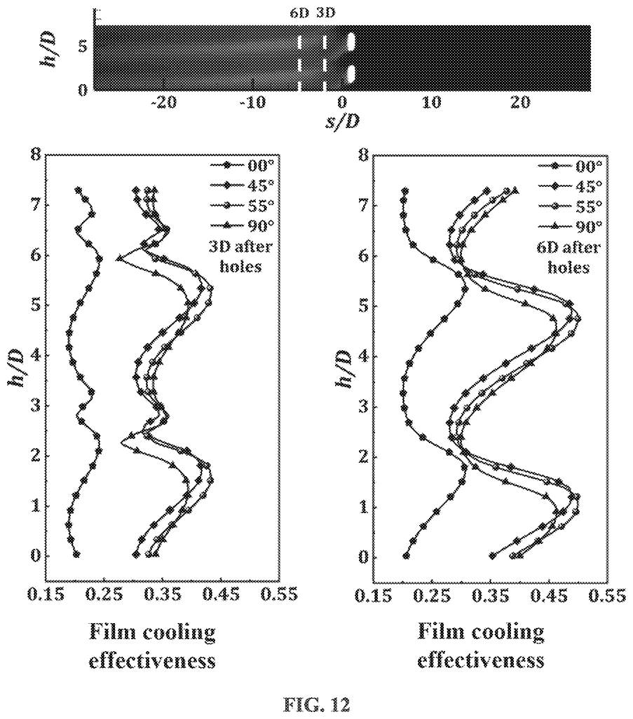

Referring to FIG. 12, to qualitatively analyze film cooling effectiveness of slot holes with different exit rotation angles at pl, a radial film cooling effectiveness distribution at 3D and 6D after the holes along the mainstream flow direction are extracted, the horizontal axis representing the film cooling effectiveness, and longitudinal axis representing a dimensionless height. As can be seen from the figure, regardless of 3D or 6D after the holes, the film with the slot holes designed with the present disclosure has higher peak and valley values than other slot-hole structures in terms of film cooling effectiveness, and thus the cooling effectiveness is improved.

Therefore, as described above, the design method of the slot-hole showerhead structure for a leading edge of a turbine guide vane provided by the present disclosure first dynamically determines an optimal quantity of hole rows based on the total mass flow rate of the coolant, ensuring efficient distribution of cooling resources. Through the row-by-row iterative optimization on the hole row spacing, the hole row layout corresponding to the peak value of the film cooling effectiveness is accurately positioned, which breaks through the limitations of traditional empirical hole arrangement. Most importantly, driven by physical mechanisms, the resultant vector direction for the tangential component of the coolant mass flux and the mainstream mass flux is quantitatively computed at each opening position to scientifically determine the exit rotation angle of the slot hole, such that the coolant jet covers the wall in the optimal direction perpendicular to the broad edge. This completely solves the problem of blindly adjusting the position and rotation angle of the slot hole based on qualitative experience in the prior art. In addition, the design method of the present disclosure not only greatly reduces the computational cost and trial-and-error cycle required by the traditional exhaustive hole optimization, but also significantly improves the film coverage efficiency and cooling uniformity of the slot holes through a systematic procedure, providing a quantifiable and reusable design paradigm for high-performance leading edge cooling structures of the turbine vanes.

It should be finally noted that the above features mentioned and/or illustrated in the description on the exemplary embodiments of the present disclosure may be incorporated into one or more other embodiments in the same or similar manner, combined with features in the other embodiments or substituted for corresponding features in the other embodiments. Technical solutions obtained by combination or substitution also should be deemed as including in the protection scope of the present disclosure.

What is claimed is:

1. A slot-hole showerhead structure for a leading edge of a turbine guide vane, comprising: a plurality of rows of slot holes formed in a leading edge of a turbine guide vane, wherein the plurality of rows of slot holes are arranged in parallel along a vane height direction;
a quantity of hole rows for the slot holes is determined based on a total mass flow rate of a coolant on the leading edge of the turbine guide vane and a preset blowing ratio range;
a hole row spacing is determined via iterative optimization, whereby area-averaged film cooling effectiveness of each hole row on the leading edge of the turbine guide vane reaches a peak value; and
an exit rotation angle of each slot hole is set, whereby a broad edge of the slot hole is perpendicular to a resultant vector direction for a coolant mass flux and a mainstream mass flux at a hole exit.

2. A design method of the slot-hole showerhead structure for the leading edge of a turbine guide vane according to claim 1, comprising following steps:
step 1, determining the quantity of hole rows: based on the total mass flow rate of the coolant on the leading edge of the turbine guide vane and a total cross-sectional area of the slot holes, selecting, via iterative computation, the quantity of hole rows meeting the preset blowing ratio range;
step 2, determining positions of the hole rows: according to a geometrical boundary of the leading edge of the turbine guide vane, setting a first hole row at a stagnation line of the leading edge; and with a minimum safe spacing as a constraint, determining remaining hole rows at two sides of the stagnation line via row-by-row iterative optimization, whereby the area-averaged film cooling effectiveness of the hole row on the leading edge of the turbine guide vane reaches the peak value; and
step 3, designing the exit rotation angle of the slot hole, comprising following sub-steps:
sub-step 3.1, for a determined opening position of the slot hole, extracting a mainstream total pressure, a mainstream static pressure, a mainstream density, a coolant velocity, and a coolant density via numerical simulation;
sub-step 3.2, through the mainstream total pressure, the mainstream static pressure, and the mainstream density of the opening position, computing a mainstream velocity of the opening position, and further computing a corresponding mainstream mass flux:
$${v}_{g}^{kj} = \sqrt{\frac{2 ( {P}_{t}^{kj} - {P}_{s}^{kj} )}{{ρ}_{g}^{kj}}}$$
$${τ}_{g}^{kj} = {ρ}_{g}^{kj} {v}_{g}^{kj}$$
wherein, k is a row number of the slot hole, j is a number of the slot hole in each row, v_{g} is the mainstream velocity, Pₜ is the mainstream total pressure, Pₛ is the mainstream static pressure, ρ_{g} is the mainstream density, and τ_{g} is the mainstream mass flux;
sub-step 3.3, through the coolant velocity and the coolant density of the opening position, computing a coolant mass flux of the opening position:
$${τ}_{c}^{kj} = {ρ}_{c}^{kj} {v}_{c}^{kj}$$
wherein, τ_{c} is the coolant mass flux, ρ_{c} is the coolant density, and v_{c} is the coolant velocity; and
sub-step 3.4, according to the mainstream mass flux and the coolant mass flux of the opening position, computing the exit rotation angle of the slot hole:
$${θ}^{kj} = arctan \frac{{τ}_{c}^{kj} cos γ}{{τ}_{g}^{kj}}$$
wherein, θ is the exit rotation angle of the slot hole, and γ is a hole inclination angle of the slot hole.

3. The design method of the slot-hole showerhead structure for a leading edge of a turbine guide vane according to claim 2, wherein the step 1 comprises:
sub-step 1.1, preliminarily selecting the quantity of hole rows, determining a quantity of slot holes in the row, and computing the total cross-sectional area of the slot holes;
sub-step 1.2, according to cooling design requirements, determining the total mass flow rate of the coolant on the leading edge of the turbine vane, and computing an average blowing ratio for the leading edge of the turbine guide vane:
$$\overline{M} = \frac{{\dot{m}}_{c} / {A}_{e}}{{\overline{ρ}}_{g} {\overline{v}}_{g}}$$
wherein, M̅ is the average blowing ratio, \dot{m}_{c} is the total mass flow rate of the coolant, Aₑ is the total cross-sectional area of the slot holes, ρ̅_{g} is an average mainstream density, and v̅_{g} is an average mainstream velocity; and
sub-step 1.3, determining whether the computed average blowing ratio is within the preset blowing ratio range; if yes, determining the quantity of hole rows; and if no, returning to the step 1.1 to redetermine the quantity of hole rows.

4. The design method of the slot-hole showerhead structure for a leading edge of a turbine guide vane according to claim 3, wherein in the step 1.3, the preset blowing ratio range is 1.5 to 2.0.

5. The design method of the slot-hole showerhead structure for a leading edge of a turbine guide vane according to claim 4, wherein in the step 1.1, the total cross-sectional area of the slot holes is computed by equivalently taking the slot holes as circular holes:
$${A}_{e} = N w \frac{π {D}^{2}}{4}$$
wherein, N is the quantity of hole rows, w is the quantity of slot holes in the row, and D is an equivalent diameter of the slot hole.

6. The design method of the slot-hole showerhead structure for a leading edge of a turbine guide vane according to claim 5, wherein in the step 1.1, the quantity of slot holes in the row is determined by a vane height, a hole spacing in the row, and a reserved size at a top of the turbine guide vane and a root of the turbine guide vane.

7. The design method of the slot-hole showerhead structure for a leading edge of a turbine guide vane according to claim 6, wherein in the step 1.1, the hole spacing in the row is 3 D to 5 D.

8. The design method of the slot-hole showerhead structure for a leading edge of a turbine guide vane according to claim 7, wherein in the step 1.1, the reserved size at the top of the turbine guide vane and the root of the turbine guide vane is 8 D to 15 D.

9. The design method of the slot-hole showerhead structure for a leading edge of a turbine guide vane according to claim 3, wherein the row-by-row iterative optimization in the step 2 comprises:
sub-step 2.1, for a k th hole row, generating an arithmetic candidate spacing
$${s}_{k}^{i} = ( 2 + 0.1 i ) D ,$$
i=0, 1, 2 . . . and D being an equivalent diameter of the slot hole;
sub-step 2.2, computing area-averaged film cooling effectiveness
$${η}_{k}^{i}$$
of the k th hole row on the leading edge under each candidate spacing
$${s}_{k}^{i}$$
via numerical simulation; and
sub-step 2.3, terminating iteration if
$${η}_{k}^{i} > {η}_{k}^{i + 1} ,$$
determining
$${η}_{k}^{i}$$
as peak cooling effectiveness, and selecting
$${s}_{k}^{i}$$
as an optimal spacing.
